(19) United States
(12) Patent Application Publication
(10) Pub. No.: US 2015/0145815 A1
(43) Pub. Date: May 28, 2015

(54) MULTI-TOUCH SENSING ARRANGEMENT

(71) Applicant: Zytronic Displays Limited, Blaydon On Tyne (GB)

(72) Inventor: Andrew Morrson, Gateshead (GB)

(21) Appl. No.: 14/400,967

(22) PCT Filed: May 31, 2013
(86) PCT No.: PCT/GB2013/051447

§ 371 Date: Nov. 13, 2014

(30) Foreign Application Priority Data
May 31, 2012 (GB) 1209736.6

(51) Int. Cl. G06F 3/044

(52) U.S. Cl. CPC G06F 3/044; G06F 2203/04104; G06F 2203/04111
USPC 345/174

(57) ABSTRACT

A multi-touch sensing panel arrangement for a display screen comprising a panel including a plurality of electrically isolated conductors crossing each other at a plurality of intersection points and a touch detector. The touch detector is arranged to detect a user touch by detecting a reduction in energy transferred by capacitive coupling between the conductors that cross at the intersection points, a reduction in capacitively coupled energy detected at a given intersection corresponding to a user touch detected at that intersection point. Each of the plurality of electrically isolated conductors comprise a conducting wire individually insulated with an insulating coating.

### TECHNICAL FIELD

The present invention relates to arrangements for detecting user touch input for use in touch sensing displays and in particular for detecting user multi-touch, i.e. one or more touch inputs from a user at the same time.

### BACKGROUND

Personal computing devices equipped with touch sensing displays are well known and widely used. Such displays allow a user to control a device by “touch inputs”, i.e. by touching a touch sensing panel typically positioned over a display screen.

Recent advances in so-called “multi-touch” technology have allowed the development of multi-touch devices, whereby a touch sensing display of a device can derive control information from multiple simultaneous touches by a user. Multi-touch technology increases the amount of control a user has over a device and increases the usefulness and desirability of the device.

Development of multi-touch technology has been mainly limited to comparatively small-scale personal computing devices such as smart-phones and tablet computers. However, there is recognition that providing multi-touch touch sensing displays in other areas could lead to improved devices of other types.

Conventional multi-touch display devices use a so-called “mutual capacitance” technique whereby the level of charge transferred from a first set of conductors (i.e. electrodes) to a second set of conductors by virtue of capacitive coupling is monitored. A reduction in this charge transfer indicates a user touch. Other techniques can be used to detect user touch, such as so-called “self-capacitance” techniques whereby a change in capacitance of isolated conductors arranged in a grid pattern is monitored. However, self-capacitance based techniques perform poorly when trying to distinguish between multiple simultaneous touches and are therefore not appropriate for multi-touch applications.

A conventional mutual-capacitance based multi-touch display device comprises a touch-sensing panel overlaid on a display screen. The touch sensing panel includes a first array layer comprising a first set of conducting elements and a second array layer comprising a second set of conducting elements. The first and second array layers are separated by a number of insulating layers and positioned under a transparent protective substrate usually made from glass. The first and second set of conducting elements are made from indium tin oxide (ITO). ITO when deposited in thin enough layers becomes transparent and is generally considered to be the best material for use in the panels that are positioned over display screens.

The ITO conductors of the first array layer are arranged to cross the ITO conductors of the second array layer at a number of crossing points. Transfer of charge due to capacitive coupling between the ITO conductors of the first and second layers at the various crossing points is monitored. A user touch (e.g. a user bringing a finger or a capacitive stylus into close proximity or physical contact with the touch sensing panel) is detected when a drop in the level of charge transferred by capacitive coupling is detected at a crossing point. This is due to charge that would otherwise have been transferred from one conductor layer to the other at the crossing point instead being transferred into the user (or stylus).

To produce the ITO conductors a layer of ITO is deposited on a substrate. This layer is then etched using a photolithography based technique to etch gaps between individual conductors.

As mentioned above, ITO is substantially transparent to the human eye when deposited as a thin enough layer (for example ITO layers with a thickness corresponding to a resistance of 250/300 Ω/sq) therefore the optical appearance of high definition display screens is not substantially diminished by the placing on top of an ITO based multi-touch sensing panel.

However, the use of ITO has a number of drawbacks that makes it less appropriate for the manufacture of other types of devices.

For example, whilst ITO has acceptable optical properties when deposited in a thin enough layer, its resistivity is such that it becomes increasingly difficult to use ITO conductors for multi-touch sensing panels with a width larger than 500 mm. Beyond this size the resistance is such that increasingly high-powered electronics must be used to “drive” charge into the conductors which results in increased power consumption. Further, as the resistance of the conductors increases it becomes harder to accurately measure how much charge is capacitively coupled between the first and second array layers. Therefore, to make multi-touch sensing panels of larger dimensions, it is necessary to “tile” a series of discrete panels thereby increasing cost and requiring complex electronics to control the tiled array.

Moreover, to deposit an ITO layer on a substrate a so-called “sputtering” technique is used whereby ITO particles are projected at the substrate forming a thin layer. Sputtering is expensive and time consuming process and must be performed in a vacuum. Moreover, it is difficult to perform sputtering consistently i.e. providing an ITO layer of uniform thickness and resistivity. Therefore the characteristics (e.g. the “linearity”) of ITO conductors may vary from device to device. This makes it necessary to adapt the electronics controlling each individual device to take account of these variances on a device-by device basis.

Further, the use of photolithography requires the production of expensive photolithograpic masks. The cost of producing such masks means that it is mostly uneconomic to manufacture a low volume of multi-touch sensing panels making testing new designs expensive and developing low numbers of “bespoke” touch sensing panels largely impractical.

There are further drawbacks to conventional techniques for providing touch sensing panels for multi-touch devices. For example, due to the manufacturing process and the physical properties of ITO it is very difficult to provide anything other than a uniformly flat touch sensing panel. This limits the use of multi-touch touch sensing display devices to devices that have a flat or substantially flat display screen profile.

As ITO is generally considered the only suitable material from which to make the conductors of multi-touch sensing devices due to its transparency, efforts to address the drawbacks discussed above have focussed on adapting the ITO conductor structure to reduce its resistivity and to adapt the ITO based manufacturing process to make it less costly and produce more consistently deposited ITO layers.

### SUMMARY OF THE INVENTION

In accordance with a first aspect of the present invention there is provided a multi-touch sensing panel arrangement for a display screen comprising a panel including a plurality of electrically isolated conductors crossing each other at a plurality of intersection points and a touch detector. The touch detector is arranged to detect a user touch by detecting a reduction in energy transferred by capacitive coupling between the conductors that cross at the intersection points, a reduction in capacitively coupled energy detected at a given intersection corresponding to a user touch detected at that intersection point. Each of the plurality of electrically isolated conductors comprises a conducting wire individually insulated with an insulating coating.

In accordance with this first aspect of the invention, a mutual capacitance based multi-touch sensing panel arrangement is provided which can be manufactured using a manufacturing process that is more simple and less costly than conventional techniques. More specifically, in contrast to conventional techniques, rather than using electrically isolated conductors that have been formed by depositing layers of ITO on non-conductive substrates and then creating individual ITO conductors using photolithography, instead the conductors in accordance with this aspect of the invention are formed from individually insulated conducting wires.

It has been recognised that whilst using individually insulated conducting wires may compromise to some extent the aesthetic of the display screen (e.g. the wires may be partially visible in front of a display screen on which the device is installed), for many applications (such as larger scale devices like public display screens or industrial control panels) individually insulated conducting wires provide an acceptable level of transparency whilst providing substantial design, manufacturing and other benefits.

Using individually insulated conducting wires rather than deposited and etched ITO greatly simplifies the manufacturing process as the wires can simply be placed on the panel substrate using any suitable direct wire process such as one which uses a plotting machine controlled in accordance with a design stored in a CAD file. Multi-touch sensing panels arranged in accordance with the present invention can be manufactured with no need for the production beforehand of expensive photolithography masks. A typical ITO multi-touch sensing panel requires at least three masks: one for forming an array of X-conductors, one for forming an array of Y-conductors and one for forming the contact leads that connect the X-conductors and the Y-conductors with the external electronics. In accordance with the present invention, there is no requirement for any masks to be produced. Furthermore, in accordance with this aspect of the present invention there is no requirement to use the expensive and inconsistent ITO sputtering process. As a result the cost of manufacturing a “one-off” panel is little different to manufacturing a large volume of panels and new panel designs can be produced much more quickly.

Furthermore, ITO contains indium which is expensive due to its rarity. Manufacturing costs aside, the raw material cost for a multi-touch sensing panel arranged in accordance with the present invention will typically be lower than an equivalent ITO based multi-touch sensing panel.

Furthermore, the use of ITO in conventional multi-touch sensing panels results in a yellow colouration. As will be understood, this can have a detrimental effect on the appearance of what is displayed on a display screen positioned below such a multi-touch sensing panel. As will be understood, as multi-touch sensing panels arranged in accordance with the present invention need not contain any ITO, there is no “yellowing” caused by ITO.

Similarly, ITO is known to be particularly reflective of sunlight. Accordingly, the performance of conventional ITO based multi-touch sensing panels outdoors can be poor as light from the display screen behind the panel can be masked by reflected sunlight. In contrast, as multi-touch sensing panels arranged in accordance with the present invention need not contain any ITO, problems associated with reflecting of sunlight due to ITO are mitigated.

Furthermore, the so-called “z-axis projection” (i.e. the distance from the conductors that a user finger or stylus needs to be to capacitively couple charge away from the conductor array and thereby register a touch) is greater when using conducting wires than when using thin layers of ITO. As a result, using insulated conducting wires as the conductors means that the transparent substrate under which the conductors are typically positioned can be much thicker than is possible with ITO based conductors. Accordingly, multi-touch sensing panels arranged in accordance with the present invention can be built to be more rugged and resilient than conventional ITO based multi-touch sensing panels.

In some embodiments, the plurality of electrically isolated conductors comprise a first group of X-plane conductors and a second group of Y-plane conductors, each intersection point being where an X-plane conductor crosses a Y-plane conductor. In some examples of these embodiments the X-plane conductors are arranged substantially orthogonal to the Y-plane conductors.

In some embodiments, the conducting wire comprises a metallic conductor material such as copper, nickel, tungsten or similar. The resistivity of these types of conductors is considerably lower than that of ITO. Accordingly, the size of individual multi-touch sensing panels can be far larger than is possible using ITO because larger conductor arrays can be produced without the resistivity of the array becoming prohibitive. This means larger devices can be made without the need to “tile” a group of smaller panels.

In some embodiments the plurality of electrically isolated conductors are arranged as plurality of repeating cells, each cell comprising one or more intersection points. By arranging the plurality of conductors in this fashion, a general pattern for the conductors can be generated (and stored for example as CAD file) which can readily be scaled or manipulated such as by being increased in size, decreased in size, cropped, stretched, compressed or any other such adaptation. Accordingly, a “base” conductor array pattern can be quickly and easily adapted for different applications, for example to provide a larger multi-touch sensing panel, a particularly elongated multi-touch sensing panel and so on. Moreover, if the same general pattern is used for the conductor array, then providing the pattern includes a set number of intersection points, the same touch detector (e.g. a device controller IC) can be used to detect the user input touches irrespective of the size and dimensions of the multi-touch sensing panel (for example including multi-touch sensing panels with a width up to 2500 mm).

In some embodiments the plurality of electrically isolated conductors are laid over each other forming a single conductor array layer in the panel. In accordance with these embodiments the conductors can be laid down on a supporting substrate as a single layer and in a single manufacturing step. This results in a far simpler construction than conventional multi-touch sensing panels which require conductors in the X-plane to be deposited on an entirely separate insulating layer to the conductors in the Y-plane.

In some embodiments the panel comprises the conductor array layer positioned on an adhesive layer. In some examples the adhesive layer is positioned adjacent to a protective substrate layer. In some examples the protective substrate layer is made from one of glass, polycarbonate, acrylic and polyethylene terephthalate (PET).

In some embodiments the conducting wire of the electrically isolated conductors is of diameter 8 μm to 18 μm.

In some embodiments the insulated conducting wires comprises tungsten wire of a diameter of 5 μm to 10 μm. It has been found that conducting wire made from tungsten and of this diameter provides a good aesthetic effect (i.e. the insulated conducting wires are of reduced perceptibility) whilst the diameter of 5 μm to 10 μm provides a good level of robustness and resistance to breakage during manufacture. In some embodiments the insulating coating of the electrically isolated conductors comprises a polyurethane, polyester, polyesterimide or polyimide coating. In some embodiments the insulating coating of the electrically isolated conductors is a coating of thickness 3 μm to 4 μm.

In some embodiments the touch detector is a controller unit arranged to detect a touch at an intersection point by transmitting a pulse on an X-plane conductor and monitoring a corresponding pulse energy on one or more of the Y-plane conductors, said corresponding pulse arising due to capacitive coupling between the X-plane conductor and the one or more Y-plane conductors. The touch is detected at the intersection point upon the controller unit detecting a reduction in pulse energy on one of the Y-plane conductors, compared to the other Y-plane conductors, said one of the Y-plane conductors corresponding to the intersection point.

In some embodiments the panel is non-planar and suitable for use with a corresponding non-planar display screen.

In accordance with a second aspect of the invention there is provided a multi-touch sensing display comprising a multi-touch sensing panel including a plurality of electrically isolated conductors crossing each other at a plurality of intersection points, a display screen positioned relative to the multi-touch sensing panel and a touch detector. The touch detector is arranged to detect a user touch (e.g. a user bringing their finger or a conductive stylus near to or in to physical contact with the multi-touch sensing panel) by detecting a reduction in energy transferred by capacitive coupling between the conductors that cross at the intersection points of the multi-touch sensing panel, a reduction in capacitively coupled energy detected at a given intersection point corresponding to a user touch detected at that intersection point, said touch detector arranged to generate multi-touch data for controlling the display screen based on the detected user touch. Each of the plurality of electrically isolated conductors of the multi-touch sensing panel comprises a conducting wire individually insulated with an insulating coating.

Various further aspects and features of the invention are defined in the claims.

### BRIEF DESCRIPTION OF THE DRAWINGS

Embodiments of the present invention will now be described by way of example only with reference to the accompanying drawings where like parts are provided with corresponding reference numerals and in which:

FIG. 1 provides a schematic diagram of a multi-touch sensing panel arrangement in accordance with embodiments of the invention;

FIG. 2a provides a schematic diagram of a conductor array layer arranged in accordance with embodiments of the invention;

FIG. 2b provides a schematic diagram showing a view of a multi-touch sensing panel arranged in accordance with embodiments of the invention;

FIG. 2c provides a schematic diagram showing an example of a conductor array pattern arranged in accordance with embodiments of the invention;

FIG. 3 provides a schematic diagram of a cross section of an insulated conducting wire arranged in accordance with embodiments of the invention;

FIG. 4 provides a schematic diagram of a multi-touch sensing panel arranged in accordance with embodiments of the invention;

FIG. 5 provides a schematic diagram illustrating a conductor array manufacturing technique for manufacturing conductor arrays in accordance with embodiments of the invention;

FIG. 6 provides a schematic diagram illustrating a touch detector unit arranged in accordance with embodiments of the invention;

FIG. 7 provides a schematic diagram of a flexible conductor array sheet arranged in accordance with embodiments of the invention;

FIG. 8 provides a schematic diagram showing an example of a rolling technique for manufacturing a non-planar multi-touch sensing panel in accordance with embodiments of the invention;

FIG. 9 provides a schematic diagram of a non-planar multi-touch sensing panel arranged in accordance with embodiments of the invention, and

FIG. 10 provides a schematic diagram of a non-planar multi-touch sensing panel connected to a touch detector unit arranged in accordance with embodiments of the invention.

### DETAILED DESCRIPTION

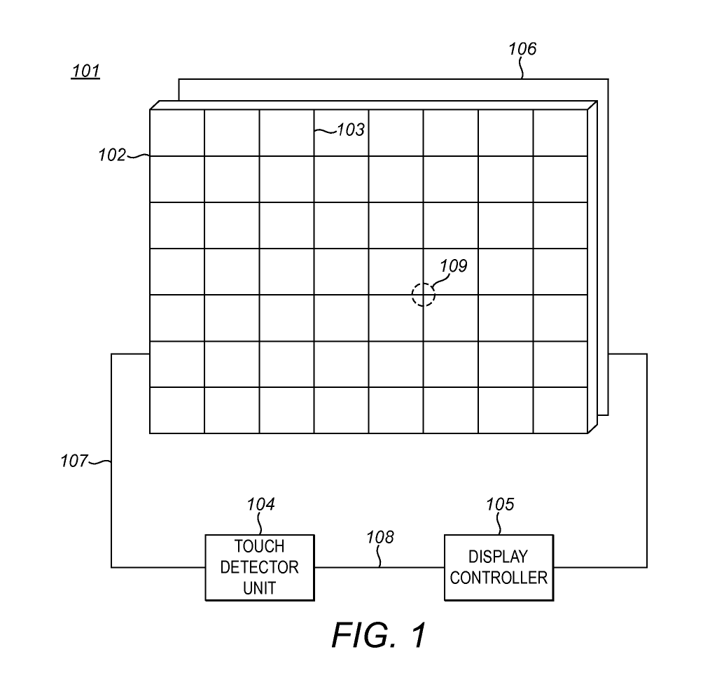

FIG. 1 provides a schematic diagram of a multi-touch sensing panel arrangement 101 in accordance with an example of the invention. The multi-touch sensing panel arrangement is arranged to detect “multi-touch” input, i.e. input from a user comprising one or more touch inputs at the same time.

A multi-touch sensing panel 102 is provided which includes a conducting array layer 103 comprising a plurality of insulated conducting wires arranged into a first group of X-plane conductors and a second group of Y-plane conductors. Each conducting wire is individually insulated with an insulating coating.

Each of the insulated conducting wires from both the X-plane conductor group and the Y-plane conductor group are connected via a flexi-lead connector 107 to a touch detector unit 104. The touch detector unit 104 includes an output 108 enabling it to be connected to a display controller 105. The display controller 105 is arranged to control a display screen 106 over which the multi-touch sensing panel can be positioned. As will be understood, the display controller 105 is typically any suitable display controlling device such as a personal computer, games console, control circuitry of a television and so on. The display screen 106 is any display apparatus which can be positioned adjacent to a multi-touch sensing panel. Such display screens include LCD display screens, CRT display screens, projection based display screens and so on.

As will be understood, the multi-touch sensing panel 102, touch detector unit 104 and display screen together form a multi-touch sensing display.

The conducting array layer 103 includes a number of intersection points 109 where an insulated conducting wire from the group of X-plane conductors crosses an insulated conducting wire from the group of Y-plane conductors.

In operation the touch detector unit is arranged to sequentially generate a voltage pulse on each of the insulated conducting wires of the X-plane conductor group and at the same time monitor the voltage level on each of the insulated conducting wires of the Y-plane conductor group.

By virtue of capacitive coupling between the insulated conducting wires at the intersection points, a voltage pulse generated on a given X-plane insulated conducting wire will result in a corresponding voltage pulse on all of the Y-plane insulated conducting wires that cross the given X-plane insulated conducting wires at the various intersections. As will be understood by those skilled in the art capacitive coupling “at” an intersection point refers to capacitive coupling substantially in the vicinity of the intersection point. The size of the pulse on each Y-plane insulated conducting wires that cross the X-plane insulated conducting wire will depend on the extent of the capacitive coupling between the insulated conducting wires at the intersections.

Normally when there is no user touch (i.e. a user has not brought any part such as a user finger or capacitive stylus into close proximity or physical contact with the multi-touch sensing panel 102) the voltage pulse generated on the Y-plane insulated conducting wires will be at a given, substantially constant, level. However, if there is a user touch at an intersection point (i.e. a user bringing a part, such as a body part or suitable capacitive pointing device, into close proximity or physical contact with the multi-touch sensing panel 102), then some of the energy from the voltage pulse on the X-plane insulated conducting wire will be absorbed, by capacitive coupling, into the user part. As a result there is a reduction in the size of the voltage pulse (i.e. the energy) measured at the particular Y-plane insulated conducting wire that crosses the pulsed X-plane insulated conducting wire.

By sequentially pulsing each of the X-plane insulated conducting wires and measuring the corresponding voltage pulses on the Y-plane insulated conducting wires, the touch detector can determine at what intersection points there are user touches. The touch detector pulses the X-plane conductors and measures the corresponding pulse on the Y-plane conductors at a sufficient frequency such that simultaneous user touches (i.e. multi-touch) at any of the intersection points can be detected.

Multi-touch data, indicating where there are user touches, is then generated by the touch detector unit 104 which can then be sent, via the touch detector unit output 108, to a display controller 105 that is arranged to control a display screen 106 in accordance with multi-touch data.

For example, if the display screen 106 is displaying an image, a user might place a thumb and forefinger on the multi-touch sensing panel 102 at a position corresponding to where the image is displayed on the display screen 106. The user may then twist their hand thereby rotating the thumb and forefinger around a central point. This user input is detected by the touch detector unit 104 as described above and multi-touch data corresponding to the position and the movement of the user's thumb and forefinger generated and sent to the display controller 105. The display controller 105 may then be arranged to determine that a user touch was made on an area of the multi-touch sensing panel corresponding to an area of the display screen 106 where the image is displayed and therefore that the user has selected the image for manipulation. Further, the display controller 105 may then be arranged to change the display of the image in accordance with an operation associated with the thumb/forefinger rotation movement described above by, for example, rotating the image displayed on the display screen 106.

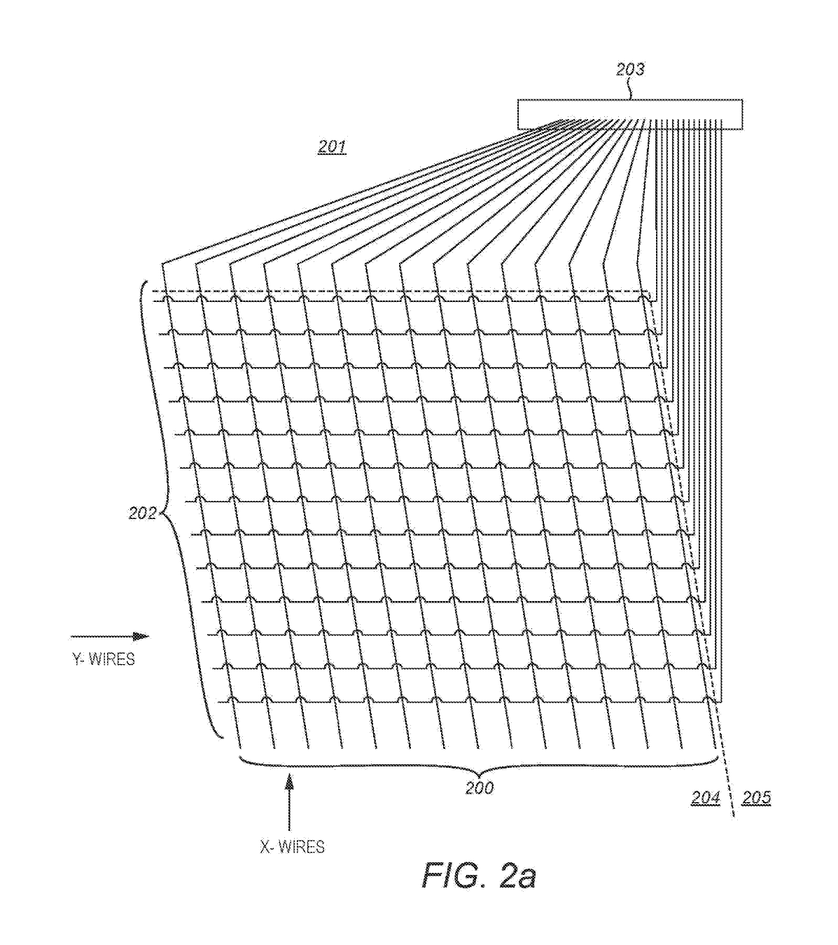

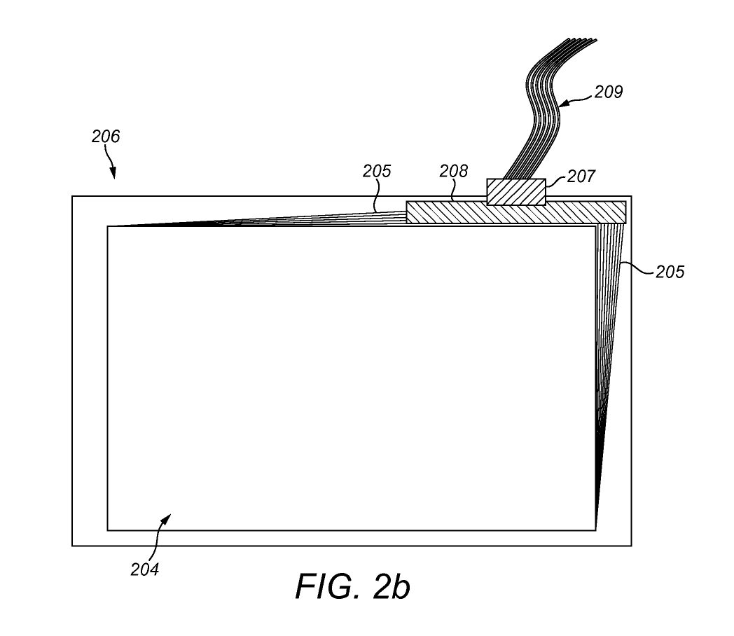

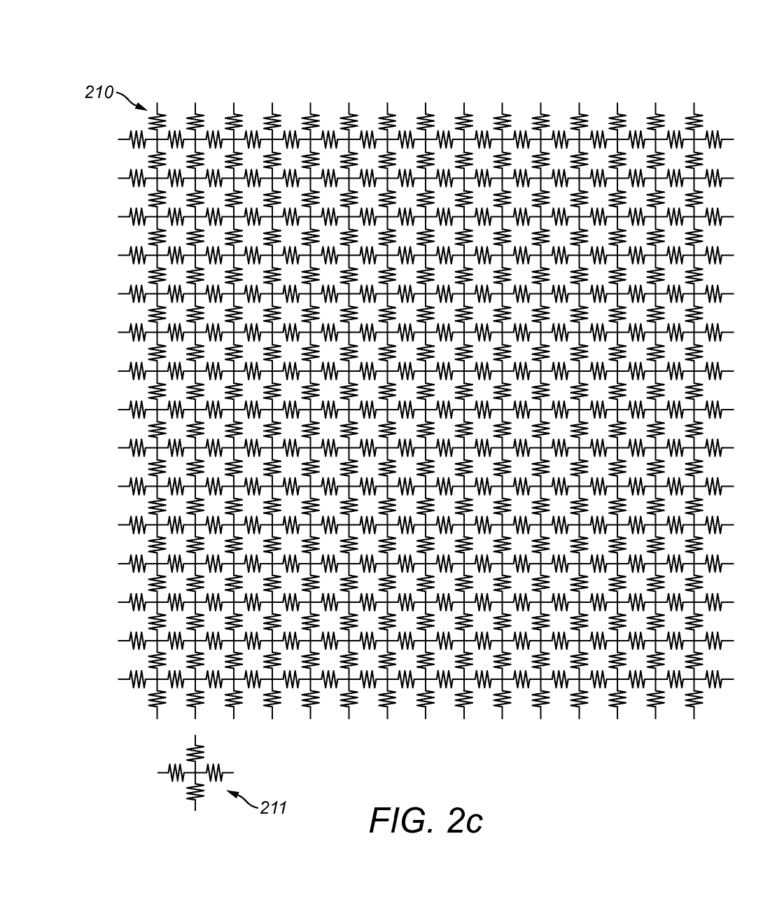

FIG. 2a provides a schematic diagram of a conductor array layer 201 arranged in accordance with an embodiment of the invention.

As described above, the conductor array layer 201 comprises a plurality of insulated conducting wires arranged into an X-plane group of insulated conducting wires 200 and a Y-plane group of insulated conducting wires 202. Typically the insulated conducting wires of the X-plane group are arranged substantially orthogonally to the insulated conducting wires of the Y-plane group.

The insulated conducting wires terminate at a termination point 203 and are connected at this point to one or more flexi-tail connectors for electrical connection with a touch detector unit.

Typically, a first portion 204 of the conductor array 201 is positioned substantially within an area of the multi-touch sensing panel that receives touch input from a user. A second portion 205 includes signal lines connected to each insulated conducting wire leading to the termination point and is typically positioned around a periphery of the multi-touch sensing panel. Typically the insulated conducting wire forming a conductor in the conductor array and the corresponding signal line are formed from the same continuous section of insulated conducting wire.

As shown in FIG. 2a, the Y-plane insulated conducting wires are laid down directly on the X-plane insulated conducting wires—i.e. there is no provision of an intervening layer between the X-plane and Y-plane insulated conducting wires for the purpose of electrically isolating the insulated conducting wires from each other. As will be understood, the provision of such a layer is unnecessary because each individual insulated conducting wire is electrically isolated from the other wires by virtue of its insulating coating.

FIG. 2b provides a schematic diagram providing a more detailed view of a multi-touch sensing panel 206 arranged in accordance with an embodiment of the present invention. The multi-touch sensing panel 206 includes a conducting array layer as explained for example with reference to FIG. 2a. The conducting array layer includes the first portion 204 which, as explained above, is positioned within an area of the multi-touch sensing panel 206 which receives a touch input from a user. The conducting array layer 201 also includes the second portion 205 which includes signal lines connected to each insulated conducting wire leading to the termination point. Connected to the termination point is a flexi-tail connector 207. The flexi-tail connector 207 includes a series of connecting leads 209, typically arranged in a flat parallel formation. As will be understood, each connecting lead corresponds to an insulated conducting wire of the conducting array layer. The flexi-tail connector 207 includes a connection point 208 which is secured to the multi-touch sensing panel 206 and includes a plurality of bonds which electrically connect end-points of the signal lines to end-points of the connecting leads. As will be understood, the termination point is not shown in FIG. 2a as it is positioned below the connection point 208. At the other end of the flexi-tail connector 207 (not shown) a connector is provided for connecting each connecting lead with a suitable input line of the touch detector unit.

Although not shown in FIG. 2b, in some examples the multi-touch sensing panel may be connected to more than one flexi-tail connector. For example, the multi-touch sensing panel may be arranged to have one flexi-tail connector for the X-plane insulated conducting wires and another flexi-tail connector for the Y-plane insulated conducting wires. In another example, the X-plane insulated conducing wires and Y-plane insulated conducing wires may be divided into subsets, and the multi-touch sensing panel is arranged such that each subset has its own flexi-tail connector.

The arrangement of the insulated conducting wires shown in FIG. 2a is a simple straight-line grid pattern. However, it will be understood that any suitable arrangement of X-plane and Y-plane insulated conducting wires can be used provided the requisite intersection points are provided. FIG. 2c provides a schematic diagram showing an example of a conductor array pattern 210 comprising X-plane and Y-plane insulated conducting wires that is more complex than the simple straight-line grid pattern shown in FIG. 2a. As will be understood, the conductor array 210 comprises a number of repeating cells 211. During the design process, individual cells such as that shown in FIG. 2c can be designed and then repeated to produce the required size of conductor array. Typically each repeating cell comprises one or more intersection points.

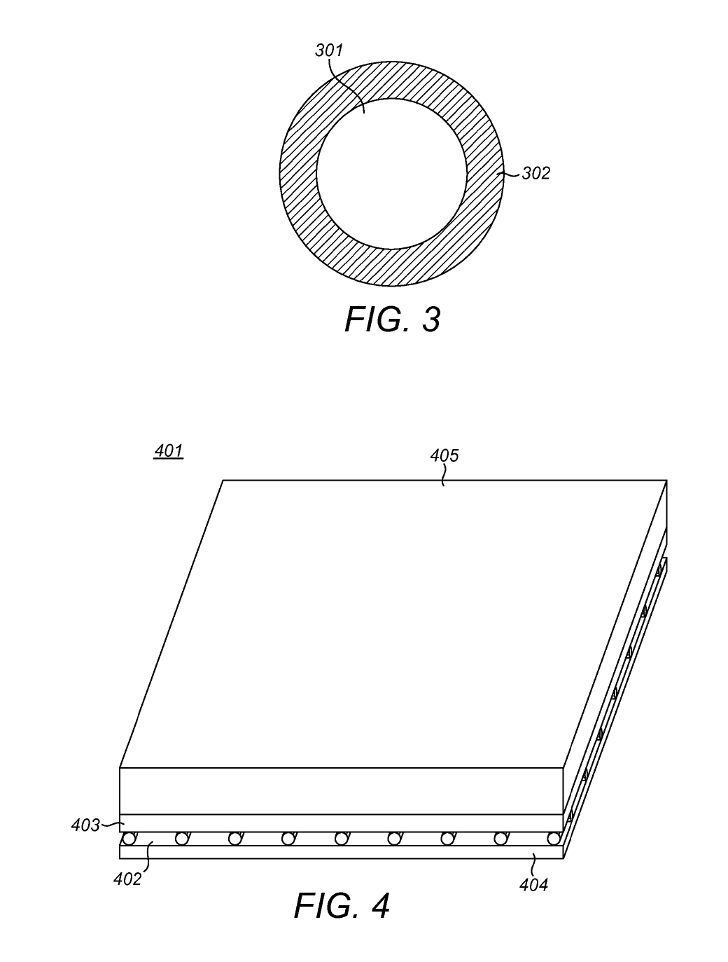

FIG. 3 provides a schematic diagram of a cross section of an insulated conducting wire arranged in accordance with an example of the invention. The insulated conducting wire comprises a conductive core 301 comprising, for example, a metallic conductor such as copper, nickel, tungsten and an insulating coating 302 comprising an insulating material such as polyurethane, polyester, polyesterimide or polyimide. Any suitable material can be used for the insulating coating providing it is flexible enough to withstand the manufacturing process and can be melted off at a suitable temperature to allow the conductive core to be bonded to the flexi-tail connector. In some examples a dye is added to the insulating material to reduce the reflectivity of the insulated conducting wires when they are in situ in a multi-touch sensing panel. This can have the effect of reducing the perceptibility of the insulated conducting wires, particularly in certain conditions such as under direct sunlight. As set out below, in some examples a lubricant is applied to the surface of the insulated conducting wires to reduce a likelihood of breakages when it is being fixed to a surface.

The conductive core need not be made from a single metallic conductor. In some examples the conductive core may comprise a first metallic conductor plated with a second metallic conductor. For example the conductive core may comprise a gold-plated tungsten core.

The dimensions of the insulated conducting wire, the conductor and coating of which it is comprised can be any suitable dimensions determined, for example, by the desire to reduce perceptibility of the conductor array layer balanced with other factors such as manufacturing constraints (e.g. if the insulated conducting wires are too fine then they are prone to break during manufacture). In some embodiments, the insulated conducting wire comprises a metallic core of diameter between 8 μm to 18 μm with an insulating coating of thickness 3 μm to 4 μm. It has been found that insulated conducting wires so arranged are small enough to provide minimised perceptibility whilst being of sufficient size to be of the required robustness during manufacturing of the multi-touch sensing panel using the manufacturing techniques described below.

In some examples, insulated conducting wires with a conductive core with a diameter towards the larger end of the range are chosen for larger sized multi-touch sensing panels to reduce a likelihood that the insulated conducting wires will snap during manufacture (larger scale multi-touch sensing panels may require longer continuous lengths of the insulated conducting wire to be laid down which increase the chance of breakage during manufacture). For example, for multi-touch sensing panels of a width near to or greater than 1000 mm, an insulated conducting wire with a conductive core made from copper and with a diameter of 18 μm can be used. On the other hand, in some examples where minimising the perceptibility of the appearance of the insulated conducting wires is of higher importance and where the manufacturing of the multi-touch sensing panel is less likely to lead to breakage of the insulated conducting wire (e.g. for smaller scale multi-touch sensing panels), insulated conducting wires with conductive cores of a smaller diameter are chosen. For example, insulated conducting wires with a tungsten core of a diameter of 5 μm to 10 μm can be used for multi-touch sensing panels with smaller dimensions (for example of a width less than 500 mm) and which are part of a touch sensing display likely to be viewed closely or for a prolonged period of time by a user. In some examples, such multi-touch sensing panels with smaller dimensions can include insulated conducting wires made from copper with a diameter of 10 μm.

Typically, for ease of manufacture each insulated conducting wire will include the insulating coating 302 along its entire length. However, it will be understood that it is only necessary to provide the insulating coating on sections of the insulated conducting wire that need electrically isolating from other components of the multi-touch sensing panel.

FIG. 4 provides a schematic diagram of a multi-touch sensing panel 401 arranged in accordance with an embodiment of the invention. The multi-touch sensing panel 401 includes a conductor array layer 402 comprising insulated conducting wires arranged, for example, as shown in FIG. 2a, and positioned on an adhesive layer 403, on which the conductor array layer 402 is secured. The adhesive layer can be any suitable transparent adhesive such as pressure sensitive adhesive (PSA) or optically clear adhesive (OCA) that are known in the art. The multi-touch sensing panel 401 also includes a protective backing layer 404, comprising, for example, a polyethylene terephthalate (PET) film, and a protective substrate positioned 405 on the adhesive layer.

As will be understood, the protective substrate 405, adhesive layer 403 and the protective backing layer are all substantially transparent.

The protective substrate 405 can be made from any suitable transparent material such as polycarbonate, glass, acrylic or PET. The protective substrate 405 is typically the layer that is exposed for users to touch.

The signal lines and the termination point described above with reference to FIG. 2a are not shown in the schematic diagram of the multi-touch sensing panel shown in FIG. 4, however, it will be understood that these components are typically incorporated as part of the multi-touch sensing panel.

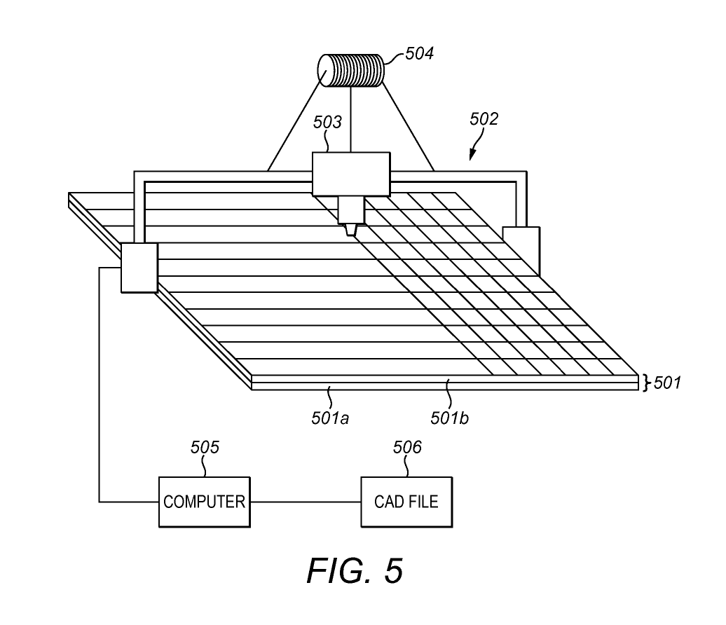

FIG. 5 provides a schematic diagram illustrating a technique that can be used to manufacture the conductor array layer for multi-touch sensing panels in accordance with embodiments of the invention.

A base layer 501 comprising a protective substrate 501a and an adhesive layer 501b is positioned within a wire plotting apparatus 502. The plotting apparatus 502 includes a wire deploying head 503 which can move over the surface of the adhesive layer 501b laying down wire, such as the insulated conducting wires described above. As wire emerging from the wire deploying head 503 contacts the adhesive of the adhesive layer 501b, it is fastened into position. A spool of wire 504 dispenses wire as it is fastened to the adhesive layer 501b by the wire deploying head 503. To create a conductor array such as the conductor array shown in FIG. 2a, the spool of wire 504 feeds insulated conducting wire into the wire deploying head 503 which lays down insulated conducting wire for one of the X-group or Y-group wires, and then, on top of this, lays down insulated conducting wire for the other of the X-group or Y-group wires. In some examples a lubricant is applied to the surface of the insulated conducting wire in the spool to reduce the likelihood of breakages as the wire is deployed from the spool. Once all the insulated conducting wire has been laid down and fixed to the adhesive layer 501b, the necessary cuts are made to form each individual insulated conducting wire. The cutting can be done by hand; or can be done by fixing a cutting tool to the wire deploying head, or can be done by using any other suitable technique.

The plotting apparatus 502 is controlled by a computer 505. The computer 505 is programmed to control the plotting apparatus 502 to lay down the insulated conductor wires to form a conductor array layer as specified in a computer aided design (CAD) file 506. As will be understood, in order to change some aspect of the conductor array (for example size, shape, array pattern and so on), all that is necessary is to use a different and/or adapted CAD file.

As described above, the protective substrate 501a can be made from any suitable transparent material such as polycarbonate, glass, acrylic, PET and so on.

Once the conductor array layer has been formed on the adhesive layer 501b a protective layer is then added on top of the conductor array layer. This protective layer is typically a PET film. As will be understood, the protective substrate 501a will typically form the outer surface of the multi-touch sensing panel that is touched by the user.

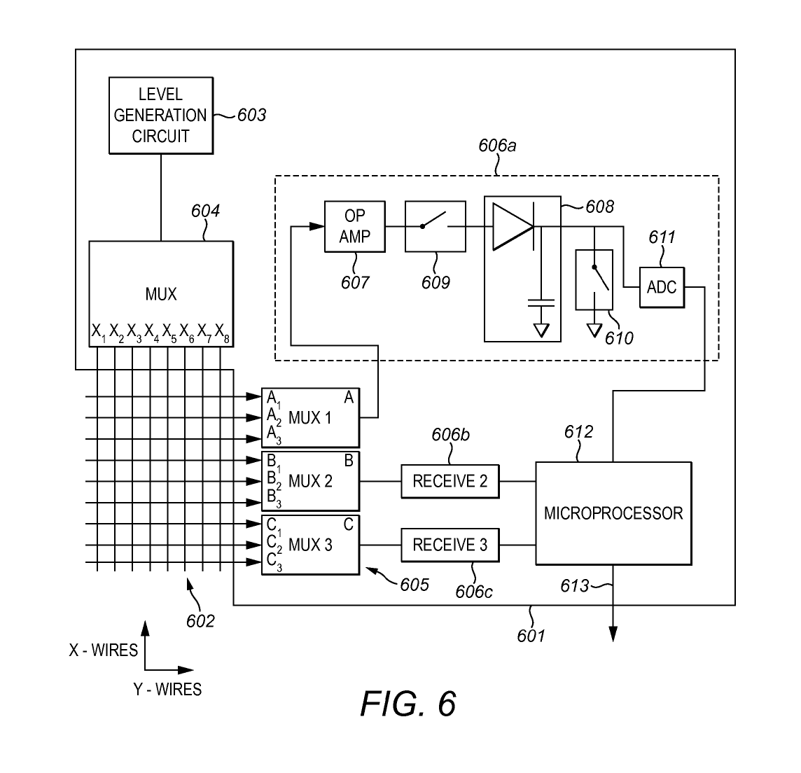

FIG. 6 provides a schematic diagram illustrating components of a touch detector unit 601 arranged in accordance with embodiments of the invention. The touch detector unit 601 is connected to a multi-touch sensing panel 602 comprising X-plane and Y-plane insulated conducting wires as described above via flexi-tail connector (not shown).

The touch detector unit 601 includes a level generation circuit 603 that generates a voltage pulse signal which is input to a multiplexer 604 connected, via the flexi-tail connector, to the X-plane insulated conducting wires of the multi-touch sensing panel 602. The multiplexer 604 selects one of the X-plane insulated conducting wires and sends the voltage pulse signal generated by the level generation circuit 603 to the selected X-plane insulated conducting wire. As explained above, energy from the voltage pulse signal is transferred to the Y-plane insulated conducting wires of the multi-touch sensing panel 602 by capacitive coupling.

The Y-plane insulated conducting wires are connected via the flexi-tail connector to one of a number of multiplexers A, B, C in a multiplexer array 605. Each multiplexer is connected to a receive circuit 606a, 606b, 606c. On the transmission of a voltage pulse signal on an X-plane insulated conducting wire, each multiplexer of the multiplexer array 605 is arranged to connect each Y-plane insulated conducting wire to which it is connected to the receive circuit 606a, 606b, 606c to which it is connected. The order in which the Y-plane insulated conducting wires are connected to the receive circuits 606a, 606b, 606c can be in any suitable order. In one example the level generation circuit 603 and multiplexer 604 sequentially send a voltage pulse signal on each X-plane conducting wire X₁ to X₈ whilst each multiplexer of the multiplexer array 605 connects a first input A₁, B₁ C₁ to the corresponding receive circuits 606a, 606b, 606c. The level generation circuit 603 and multiplexer 604 then sequentially send a voltage pulse signal on each X-plane conducting wire X₁ to X₈ whilst each multiplexer of the multiplexer array 605 connects to a second input A₂, B₂ C₂ to the corresponding receive circuits 606a, 606b, 606c. The level generation circuit 603 and multiplexer 604 then sequentially send a voltage pulse signal on each X-plane conducting wire X₁ to X₈ whilst each multiplexer of the multiplexer array 605 connects a third input A₃ B₃ C₃ to the corresponding receive circuits 606a, 606b, 606c. In this way a complete scan of the multi-touch sensing panel is performed.

As will be understood, although the multi-touch sensing panel 602 shown in FIG. 6 only includes 8 X-plane insulated conducting wire and 9 Y-plane insulated conducting wires, in most implementations there will be many more X-plane and Y-plane conducting wires (for example 80 X-plane insulated conducting wires and 48 Y-plane conducting wires). Accordingly it will be understood that in most implementations, each multiplexer of the multiplexer array 605 will have more than three Y-plane insulated conducting wire inputs and that the multiplexer 604 will have more than 8 output connections to X-plane insulated conducting wires.

Each receive circuit 606a, 606b, 606c comprises an amplifier 607, a peak detector 608, peak detector charge and discharge switches 609, 610 and an analogue to digital convertor 611.

When a receive circuit receives a voltage pulse signal, the signal is first amplified by the amplifier 607. The peak detector charge switch 609 is closed and the peak detector discharge switch 610 is opened and charge is collected by the peak detector 608. The peak detector charge switch 609 is then opened and the charge collected by the peak detector 608 is input to the analogue to digital convertor 611. The analogue to digital convertor 611 outputs a digital value corresponding to the voltage peak on the Y-plane insulated conducting wire. This is received by a microprocessor 612. The peak detector discharge switch 610 is then closed and the charge in the peak detector 608 is discharged. The peak detector charge and discharge switches 609, 610 are then re-set ready for the voltage pulse signal from the next Y-plane insulated conducting wire.

This process continues until the voltage pulse signal on each Y-plane insulated conducting wire has been measured and output as a digital value to the microprocessor 612. The multiplexer 604 then connects the level generation circuit 603 to the next X-plane insulated conducting wire. This process continues until a digital value has been sent to the microprocessor 612 for all of the intersection points of the multi-touch sensing panel 602.

Once all the digital values corresponding to the voltage pulse on each Y-plane insulated conducting wire have been input to the microprocessor 612, the microprocessor converts these values into a suitable format and then outputs multi-touch data corresponding to detected multiple user touches on the multi-touch sensing panel 602 on an output line 613. In some examples the multi-touch data simply comprises a series of data units, each data unit corresponds to one of the intersection points and includes two data values. A first data value identifies a given intersection point, and a second data value indicates an amount of energy from the voltage pulse that has been capacitively coupled across that particular intersection point.

In some examples the microprocessor performs further processing to refine the data received from the receive circuits. In some examples the microprocessor is arranged to identify which intersection points may have been subject to a user touch and then control the touch detector to perform another series of X-plane conductor pulsing focusing on those particular intersection points.

In some examples the touch detector unit is embodied in a discrete integrated circuit (IC) package. However, it will be understood that in other examples the components and functionality associated with the touch detector unit 601 are distributed within a larger system in any appropriate fashion.

In accordance with some examples of the invention, techniques are provided for producing a non-planar multi-touch sensing panel. Such a multi-touch sensing panel would be suitable for use with a corresponding, non-planar display screen.

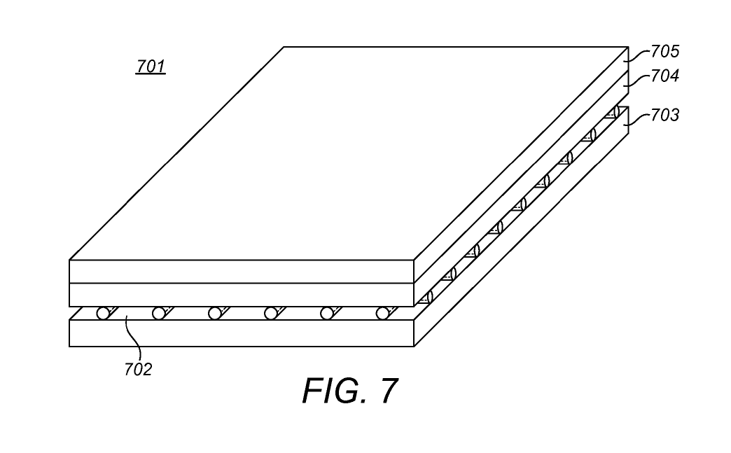

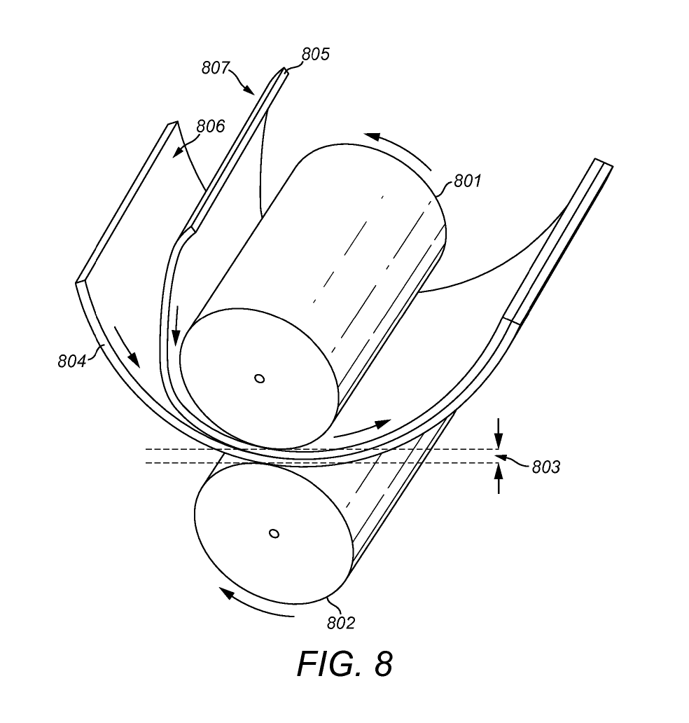

FIG. 7 provides a schematic diagram of a flexible conductor array sheet 701 arranged in accordance with an example of the invention and that can be used to produce a non-planar multi-touch sensing panel.

The flexible conductor array sheet 701 comprises a conductor array layer 702 positioned on an adhesive layer 704.

The flexible conductor array sheet 701 further comprises a first protective film layer 703 positioned adjacent the conductor array layer 702 and a second protective film layer 705 positioned adjacent the adhesive layer 704. In some examples the first and second protective film layers 703, 705 each comprise a polyethylene terephthalate (PET) film. As will be understood the conductor array layer 702 can be positioned and fixed on the adhesive layer 704 in accordance with the technique described with reference to FIG. 5. In such an example, the base layer 501 described with reference to FIG. 5 will typically comprise the second protective film layer 705 and the adhesive layer 704.

The conductive core and insulating coating of the insulated conducting wires of the conductor array layer typically comprise a metallic conductor such as copper, nickel or tungsten and with an insulating coating made from any suitable flexible insulating material such as polyurethane, polyester, polyesterimide or polyimide. The insulated conducting wires typically have dimensions as mentioned above with reference to FIG. 3.

As will be understood, a conductor array fixed on an adhesive layer as described above is substantially transparent and flexible. In other words the array can be deformed to an extent away from a flat planar configuration without the insulated conducting wires breaking. The provision of the first and second protective layers in the flexible conductor array sheet help keep the conductor array in position and protects it whilst it is being manipulated during the manufacturing process.

To produce a non-planar multi-touch sensing panel a flexible conductor array sheet is laminated onto a non-planar protective substrate such as a transparent polycarbonate, glass or acrylic substrate.

Any suitable technique can be used to laminate the flexible conductor array sheet onto the protective substrate. In some examples this is by a rolling technique.

A schematic diagram showing an example of a rolling technique is provided in FIG. 8.

FIG. 8 shows a roller arrangement comprising a first roller 801 and second roller 802. The rollers are spaced apart by a gap 803. The first and second rollers 801, 802 of the roller arrangement are arranged to rotate in opposite directions. A curved transparent protective substrate 804 (made, for example, from glass, polycarbonate or acrylic) and a flexible conductor array sheet 805 (arranged, for example, in accordance with the conductor array sheet described with reference to FIG. 7) are drawn through the gap 803 between the rollers 801, 802. In one example, the curved transparent protective substrate 804 has an adhesive (such as PSA or OCA) previously applied to its inner surface 806. As the curved transparent protective substrate 804 and the flexible conductor array sheet 805 are drawn through the gap 803, the flexible conductor array sheet 805 is compressed against the curved transparent protective substrate 804 and bonded thereto by virtue of the adhesive on the inner surface 806 of the curved transparent protective substrate 804.

In other examples the flexible conductor array sheet 805 has an adhesive previously applied to its outer surface 807 in addition to, or instead of the adhesive being previously applied to the inner surface 806 of the curved transparent protective substrate 804.

In some examples one or both of the rollers 801, 802 are heated to aid the bonding of the flexible conductor array sheet 805 to the curved transparent protective substrate 804.

In some examples the roller arrangement is arranged so that the size of the gap 803 between the rollers 801, 802 can be varied to accommodate different thicknesses of the flexible conductor array sheet 805 and the curved transparent protective substrate 804.

In some examples in order to pre-apply an adhesive layer to the inner surface 806 of the curved transparent protective substrate 804, the curved transparent protective substrate 804 is passed through the rollers with an adhesive sheet which bonds to the inner surface 806 of the curved transparent protective substrate 804.

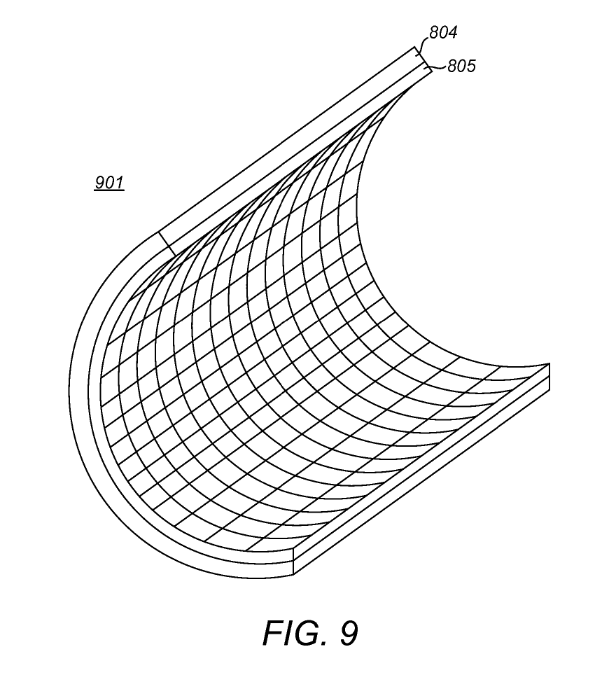

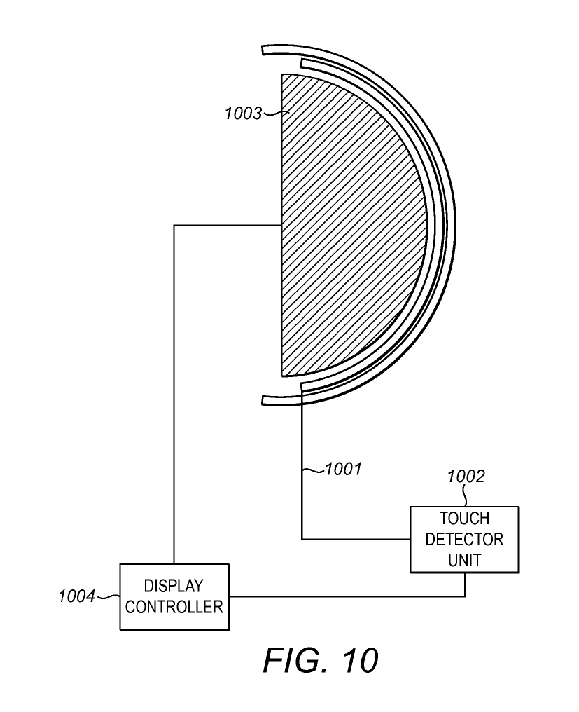

FIG. 9 provides a schematic diagram of a non-planar multi-touch sensing panel 901 produced in accordance with the technique described with reference to FIG. 8 comprising the flexible conductor array sheet 805 laminated onto the inner surface of the curved transparent protective substrate 804. The edges of the flexible conductor array sheet 805 and the curved transparent protective substrate 804 substantially correspond in FIGS. 8 and 9 although it will be understood that in some examples, the flexible conductor array sheet 805 is smaller in area than the transparent protective substrate 804 and therefore edges of the curved transparent protective substrate 804 will extend beyond the edges of the flexible conductor array sheet 805. Moreover, the signal lines and the termination point described above with reference to FIG. 2a are not shown in the schematic diagram of the multi-touch sensing panel shown in FIG. 9, however, it will be understood that these components are typically incorporated as part of the multi-touch sensing panel.

FIG. 10 provides a schematic diagram of the non-planar multi-touch sensing panel 901 described with reference to FIG. 9 connected via a flexi-tail connector 1001 to a touch detector unit 1002 and positioned relative to a suitably shaped non-planar display screen 1003. The non-planar display screen 1003 is coupled to and controlled by a display controller 1004. The touch detector unit 1002 is arranged to generate multi-touch data as described above (for example with reference to FIG. 6) and send this to the display controller 1004.

The term “multi-touch sensing” in the context of a multi-touch sensing arrangements and multi-touch sensing displays generally refers to arrangements and devices including a conductor array of X-plane conductors and Y-plane conductors from which information about multiple user touches can be derived using the mutual capacitance based techniques as described above. However, it will be understood that the term “multi-touch sensing” also refers to touch sensing arrangements that include a conductor array as described above and from which touch information can be derived using the mutual capacitance based techniques but that are adapted to only provide output touch information relating to a single user touch at any one time. For example, multi-touch sensing panel arrangements may be provided as shown in FIG. 1 or 10 except that the touch detector unit is adapted to only provide an output corresponding to a single detected user touch. In other words, in the context of the invention “multi-touch sensing” refers to detecting one or more user touches at the same time.

It will be understood that the particular component parts of which the various arrangements described above are comprised are in some examples logical designations. Accordingly, the functionality that these component parts provide may be manifested in ways that do not conform precisely to the forms described above and shown in the diagrams. For example aspects of the invention, particularly the processes running on the touch detector may be implemented in the form of a computer program product comprising instructions (i.e. a computer program) that may be implemented on a processor, stored on a data sub-carrier such as a floppy disk, optical disk, hard disk, EPROM, RAM, flash memory or any combination of these or other storage media, or transmitted via data signals on a network such as an Ethernet, a wireless network, the Internet, or any combination of these of other networks, or realised in hardware as an ASIC (application specific integrated circuit) or an FPGA (field programmable gate array) or other configurable or bespoke circuit suitable to use in adapting the conventional equivalent device.

1. A multi-touch sensing panel arrangement for a display screen comprising:
a panel including a plurality of electrically isolated conductors crossing each other at a plurality of intersection points;
a touch detector, said touch detector arranged to detect a user touch by detecting a reduction in energy transferred by capacitive coupling between the conductors that cross at the intersection points, a reduction in capacitively coupled energy detected at a given intersection point corresponding to a user touch detected at that intersection point; and
wherein each of the plurality of electrically isolated conductors comprise a conducting wire individually insulated with an insulating coating.

2. The multi-touch sensing panel arrangement according to claim 1, wherein the plurality of electrically isolated conductors comprise a first group of X-plane conductors and a second group of Y-plane conductors, each intersection point being where an X-plane conductor crosses a Y-plane conductor.

3. The multi-touch sensing panel arrangement according to claim 2, wherein the X-plane conductors are arranged substantially orthogonal to the Y-plane conductors.

4. The multi-touch sensing panel arrangement according to claim 1, wherein the plurality of electrically isolated conductors are arranged as plurality of repeating cells, each cell comprising one or more intersection point.

5. The multi-touch sensing panel arrangement according to claim 1, wherein the plurality of electrically isolated conductors are laid over each other forming a single conductor array layer in the panel.

6. The multi-touch sensing panel arrangement according to claim 5, wherein the panel comprises the conductor array layer positioned on an adhesive layer.

7. The multi-touch sensing panel arrangement according to claim 6, wherein the adhesive layer is positioned adjacent a protective substrate layer.

8. The multi-touch sensing panel arrangement according claim 7, wherein the protective substrate layer is made from one of glass, polycarbonate, acrylic and polyethylene terephthalate

9. The multi-touch sensing panel arrangement according to claim 1, wherein the conducting wire comprises a metallic conductor material.

10. The multi-touch sensing panel arrangement according to claim 9, wherein the conducting wire of the electrically isolated conductors comprises any one of copper wire, nickel wire or tungsten wire.

11. The multi-touch sensing panel arrangement according to claim 1, wherein the conducting wire of the electrically isolated conductors is of diameter 8 μm to 18 μm.

12. The multi-touch sensing panel arrangement according to claim 1, wherein the conducting wire comprises tungsten wire of a diameter of 5 μm to 10 μm.

13. The multi-touch sensing panel arrangement according to claim 1, wherein the insulating coating of the electrically isolated conductors comprises a polyurethane, polyester, polyesterimide or polyimide coating.

14. The multi-touch sensing panel arrangement according to claim 1, wherein the insulating coating of the electrically isolated conductors is coating of thickness 3 μm to 4 μm.

15. The multi-touch sensing panel arrangement according to claim 1, wherein the touch detector is a controller unit arranged to detect a touch at an intersection point by transmitting a pulse on an X-plane conductor and monitoring a corresponding pulse energy on one or more of the Y-plane conductors, said corresponding pulse arising due to capacitive coupling between the X-plane conductor and the one or more Y-plane conductors, said touch being detected at the intersection upon the controller unit detecting a reduction in pulse energy on one of the Y-plane conductors, compared to the other Y-plane conductors, said one of the Y-plane conductors crossing the X-plane conductor at the intersection point.

16. The multi-touch sensing panel arrangement according to claim 1, wherein the panel is non-planar and suitable for use with a corresponding non-planar display screen.

17. A multi-touch sensing display comprising:
a multi-touch sensing panel including a plurality of electrically isolated conductors crossing each other at a plurality of intersection points;
a display screen positioned relative to the multi-touch sensing panel;
a touch detector, said touch detector arranged to detect a user touch by detecting a reduction in energy transferred by capacitive coupling between the conductors that cross at the intersection points of the multi-touch sensing panel, a reduction in capacitively coupled energy detected at a given intersection point corresponding to a user touch detected at that intersection point, said touch detector arranged to generate multi-touch data for controlling the display screen based on the detected user touch; and
wherein each of the plurality of electrically isolated conductors of the multi-touch sensing panel comprise a conducting wire individually insulated with an insulating coating.

18. (canceled)
